(19) United States
(12) Patent Application Publication
(10) Pub. No.: US 2017/0016524 A1
(43) Pub. Date: Jan. 19, 2017

(54) Bicycle sprocket wheel

(71) Applicant: Chao-Yuan Cheng, Changhua (TW)

(72) Inventor: Chao-Yuan Cheng, Changhua (TW)

(21) Appl. No.: 15/278,025

(22) Filed: Sep. 28, 2016

(51) Int. Cl. F16H 55/30; B62M 9/00

(52) U.S. Cl. CPC F16H 55/30; B62M 9/00

(57) ABSTRACT

A sprocket wheel for a bicycle is provided with a plurality of first teeth; a plurality of second teeth alternating with the first teeth; and a plurality of recesses on one side, each recess extending from one first tooth to the adjacent first tooth via the second tooth between the two first teeth.

### BACKGROUND OF THE INVENTION

1. Field of the Invention

The invention relates to bicycle sprocket wheels and more particularly to a sprocket wheel for a bicycle, wear caused by derailing operations of the sprocket wheels being greatly decreased.

2. Description of Related Art

A conventional bicycle sprocket wheel A is shown in FIGS. 1 and 2 and comprises alternate first teeth A1 and second teeth A2. The first tooth A1 includes a cross top A11 and two sides A12. The second tooth A2 includes a straight top A21 and two sides A22. A chain B includes a plurality of inner links B1 engaging the first teeth A1 and a plurality of outer links B2 engaging the second teeth A2.

However, there is a gap between the straight top A21 and resistance is encountered by the sides A12 when the sprocket A rotates relative to the passing chain B. Both cause wear.

Thus, the need for improvement still exists.

### SUMMARY OF THE INVENTION

It is therefore one object of the invention to provide a bicycle sprocket wheel comprising a plurality of first teeth; a plurality of second teeth alternating with the first teeth; and a plurality of recesses on one side, each recess extending from one first tooth to the adjacent first tooth via the second tooth between the two first teeth.

The above and other objects, features and advantages of the invention will become apparent from the following detailed description taken with the accompanying drawings.

### BRIEF DESCRIPTION OF THE DRAWINGS

FIG. 1 is a perspective view of a portion of a conventional bicycle sprocket wheel;

FIG. 2 is a top view showing the first and second teeth of the sprocket wheel engaging the inner and outer links of a chain respectively;

FIG. 3 is a perspective view of a bicycle sprocket wheel according to the invention taken from one side;

FIG. 4 is a top view of the sprocket wheel;

FIG. 5 is an exploded view of the first and second teeth of the sprocket wheel;

FIG. 6 is a side view showing two sprocket wheels mounted with a crank;

FIG. 7 is a top view showing the first and second teeth of the sprocket wheel engaging the inner and outer links of a chain respectively;

FIG. 8 is a top view of the sprocket wheel of another configuration;

FIG. 9 is an exploded view of the first and second teeth of the sprocket wheel of FIG. 8; and

FIG. 10 is a top view showing the first and second teeth of the sprocket wheel of FIG. 8 engaging the inner and outer links of the chain respectively.

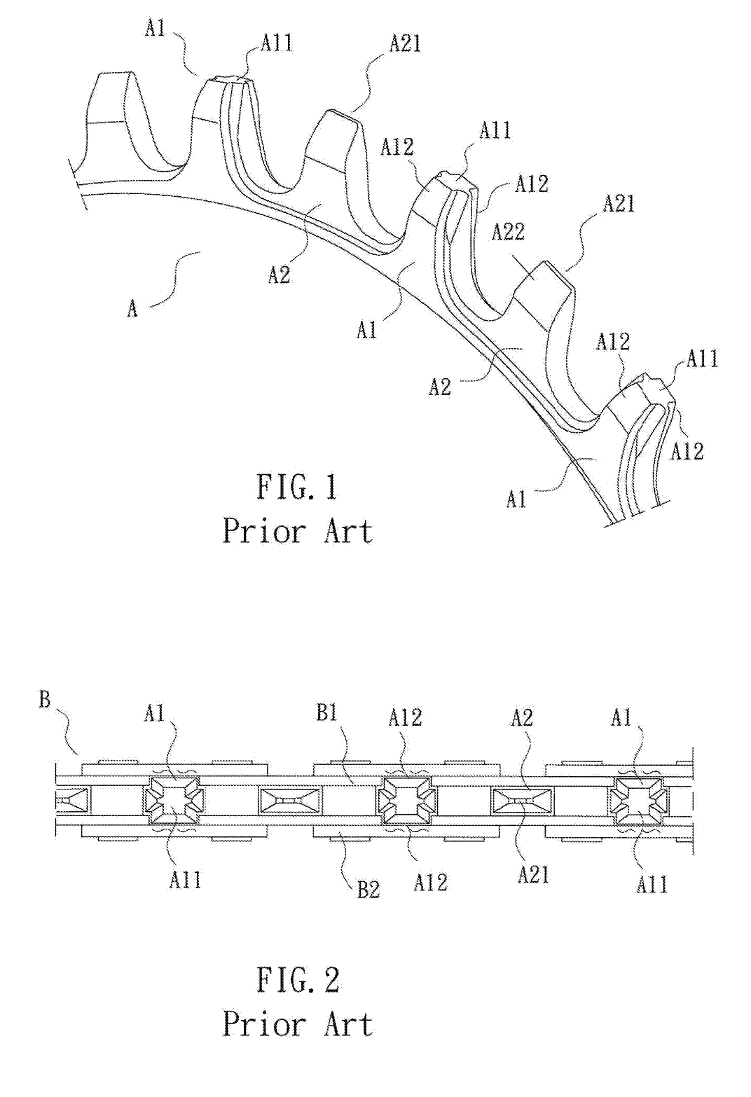

### DETAILED DESCRIPTION OF THE INVENTION

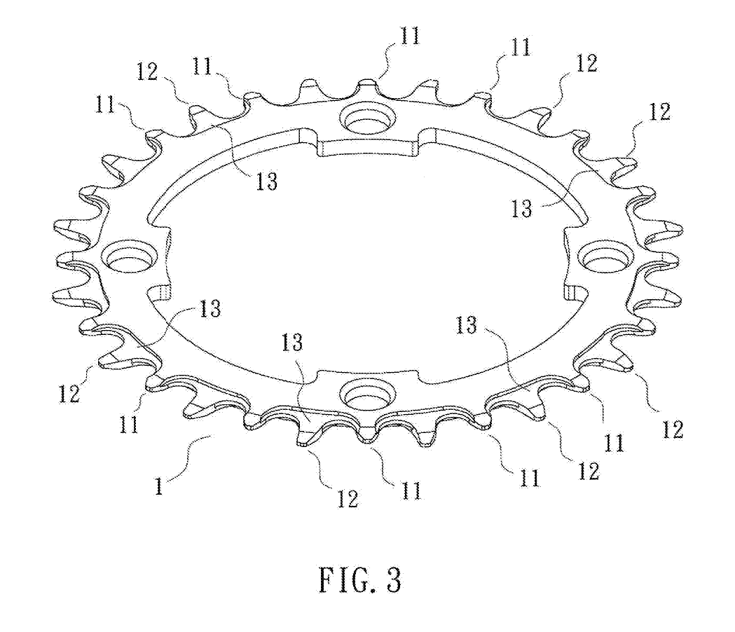

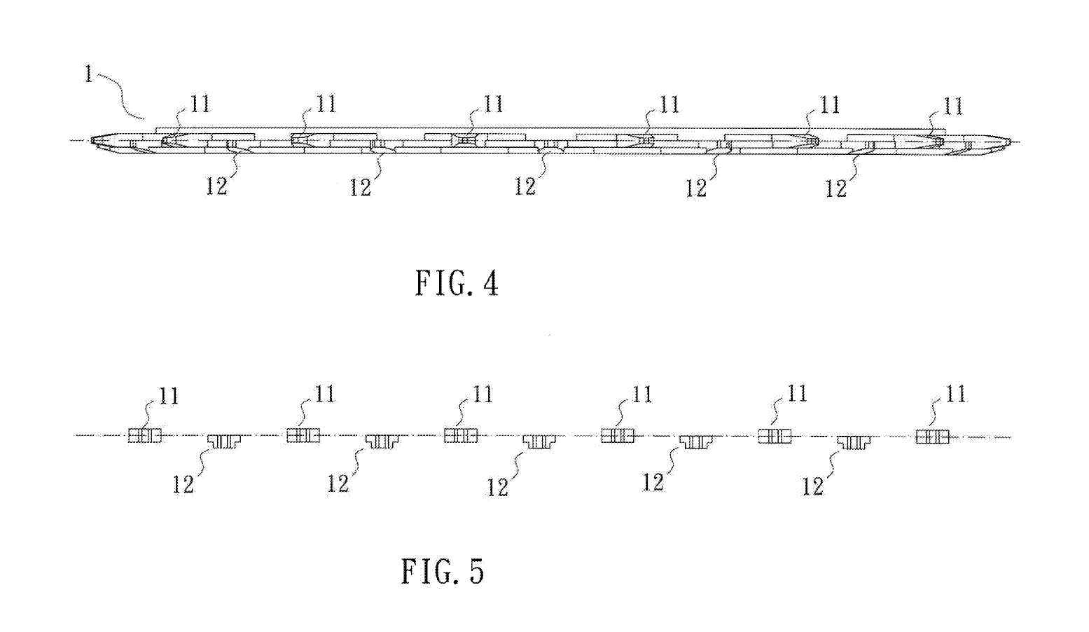

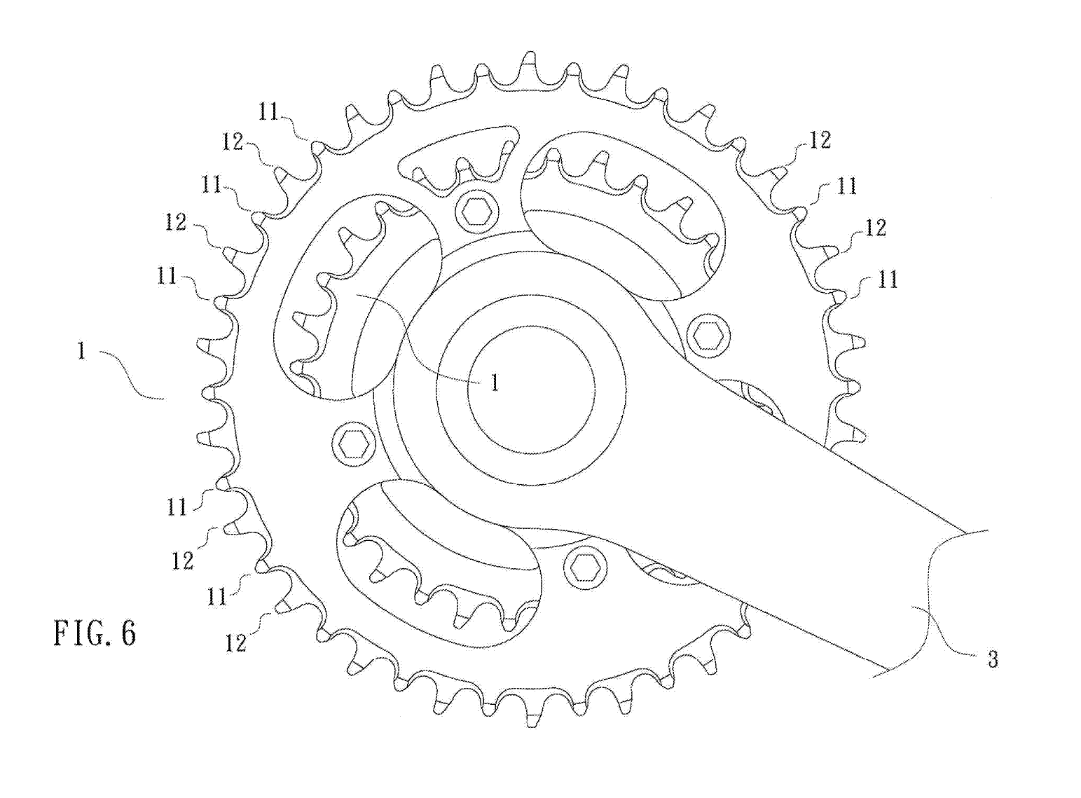

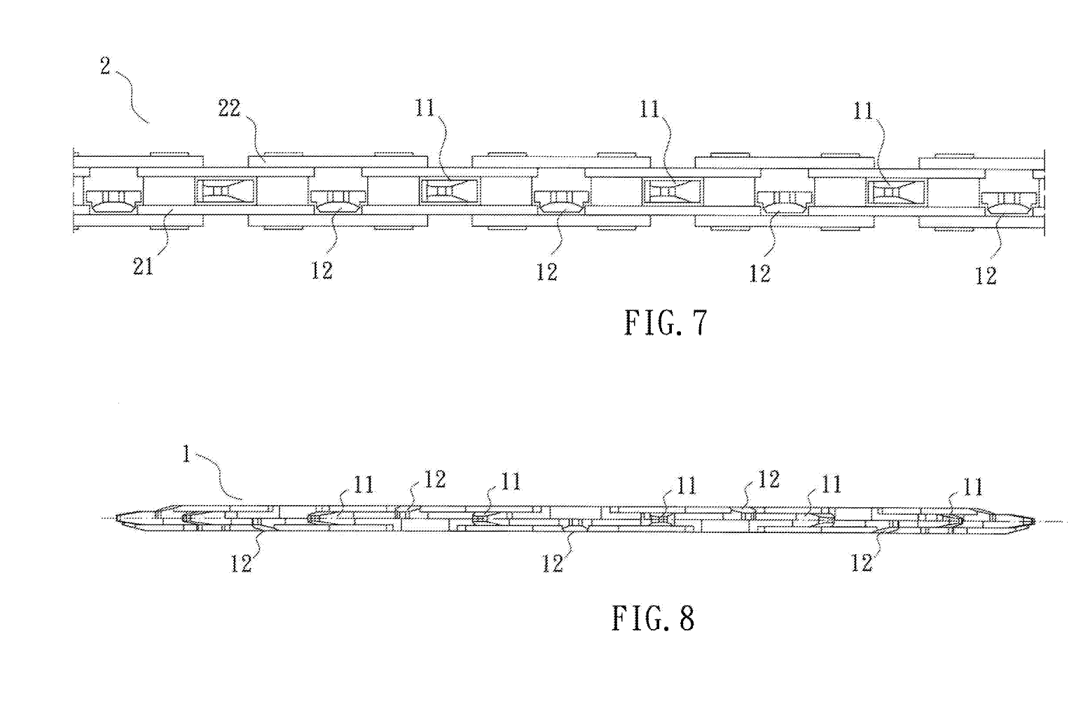

Referring to FIGS. 3 to 7, a sprocket wheel 1 of the invention is mounted with a crank 3 of a bicycle. The sprocket wheel 1 comprises a plurality of first teeth 11, a plurality of second teeth 12 alternating with the first teeth 11, and a plurality of recesses 13 on one side, each recess 13 extending from one first tooth 11 to the adjacent first tooth 11 via the second tooth 12 between the two first teeth 11. A chain 2 comprises a plurality of inner links 21 engaging the first teeth 11, and a plurality of outer links 22 engaging the second teeth 12. It is envisaged by the invention that after a predetermined number of derailing operations of the sprocket wheels, wear of the sprocket wheels 1 is less than that of the conventional art.

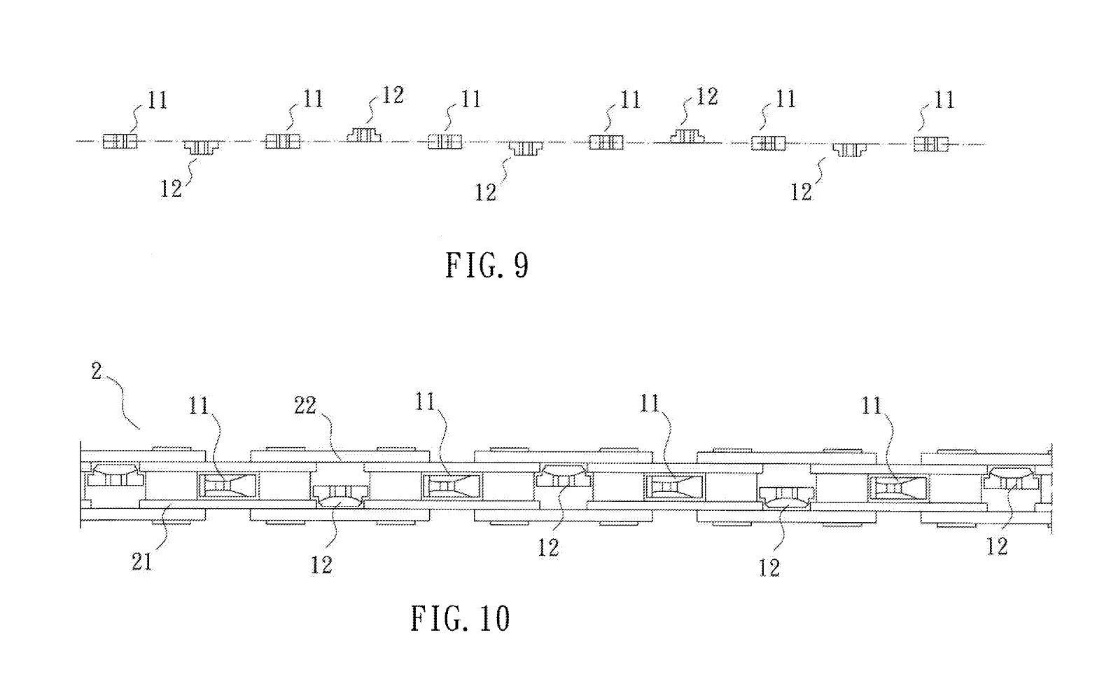

Referring to FIGS. 8 to 10, another configuration of sprocket wheel is shown. The characteristic is that the teeth sequence is a first teeth 11, a second teeth 12 at one side, another first teeth 11, another second teeth 12 at the other side and so on.

While the invention has been described in terms of preferred embodiments, those skilled in the art will recognize that the invention can be practiced with modifications within the spirit and scope of the appended claims.

What is claimed is:

1. A sprocket wheel for a bicycle, comprising:
a plurality of first teeth;
a plurality of second teeth alternating with the first teeth; and
a plurality of recesses on one side, each recess extending from one first tooth to the adjacent first tooth via the second tooth between the two first teeth.
